(19) United States
(12) Patent Application Publication
(10) Pub. No.: US 2012/0118219 A1
(43) Pub. Date: May 17, 2012

(54) MARKING DEVICE IN ELEVATOR SYSTEM

(76) Inventors: Bjarne Lindberg, Adligenswil (CH); Astrid Sonnenmoser, Ebikon (CH)

(21) Appl. No.: 13/266,961

(22) PCT Filed: Mar. 1, 2010
(86) PCT No.: PCT/EP2010/052545

§ 371 Date: Feb. 2, 2012

(30) Foreign Application Priority Data
Apr. 29, 2009 (EP) 09159061.2

(51) Int. Cl. B66B 3/02

(52) U.S. Cl. 116/201; 116/226

(57) ABSTRACT

In order to achieve simple maintenance and/or installation of an elevator system, a marking device has at least one light emitting unit for generating at least one mark on a component of the system.

The invention relates to a marking device in a lift installation, which is termed marking device in the following.

The object of the invention consists particularly in providing a device which simplifies mounting and/or maintenance of a lift component. In particular, this device shall facilitate the alignment and/or locating or recognition of components of a lift installation. According to the invention the object is fulfilled by a marking device with the features of patent claim 1 and by a marking method with the features of claim 8. Advantageous embodiments and developments of the invention can be inferred from the subclaims.

A marking device is proposed which comprises at least one light emission unit, which emits a light beam which is provided for generating at least one marking on an object present in the lift installation. By “marking” there is to be understood, in particular, a light mark which is visible preferably by reflection of the light beam on the said object, wherein the object can preferably be a lift component or an auxiliary device.

On the one hand the marking—i.e. the light mark—can mark a reference position, which, for example, serves for positioning at least one lift component, which is to be adjusted after coarse mounting has been carried out or the position of which is to be checked at the time of maintenance of the lift installation. The marking then has the function of a positioning marking. By “reference position” there is to be understood, in particular, a position starting from which a target position of at least one lift component is advantageously determinable. By “positioning” of a lift component there is to be understood, in particular, an arrangement of the lift components in a defined position or an orientation of the lift component in a defined position relative to at least one other lift component, i.e. to a reference element.

On the other hand, the marking can serve for characterisation of at least one lift component which is to be adjusted and/or to be checked and/or to be maintained and/or to be mounted. This means that in the case of mounting and particularly in the case of maintenance of the lift installation markings which characterise lift components to be maintained or to be adjusted or refer to these can be produced within the lift installation by means of at least one light beam settable in its direction. Mounting or maintenance sequences can thereby be organised so that these are faultlessly performable even by less experienced personnel.

A simple maintenance and/or mounting of a lift component can be achieved by an embodiment of the marking device in accordance with the invention. In particular, a lift component of a shaft door can be arranged precisely relative to a reference element of a lift cage, whereby, in particular, a low output of noise, for example during opening of lift doors, is achievable. In particular, a convenient capability of maintenance and, especially, a working position convenient for an engineer can be achieved, for example because a substantial spacing can be present between a lift component which is to be adjusted and a reference element. Moreover, maintenance errors can be avoided and maintenance efficiency increased in that the lift component to be maintained or checked is shown by a settable light beam. A particularly high maintenance or mounting efficiency can be achieved if the light emission unit marks two or more lift components, which are to be maintained and/or mounted, successively in time with a light beam in correspondence with a maintenance or mounting program.

The markings are preferably present as temporary positioning markings or as characterisations which do not exist in a switched-off state of the marking device according to the invention.

At least one lift device is provided for the fixing and positioning of the marking device in the lift installation. By “lift device” there is to be understood, in particular, a part of a complete lift installation at which a marking device is fastened or which is provided and designed for the fastening of a marking device. Such a lift device can comprise a fastening unit, by which the marking device is fixed to the lift device. A lift device can be present in the form of a lift shaft device or in the form of a lift cage device. By “lift shaft device” there is to be understood in that case, in particular, a lift device which is part of a lift shaft and/or is arranged at or fixed to a lift shaft. By “lift cage device” there is to be understood in that case, in particular, a lift device which is formed by a lift cage or is part of a lift cage or is mounted on a lift cage. A lift device or a fastening unit present at the lift device can comprise a positioning device which facilitates positioning or adjusting of the marking device at the lift device. A “positioning device” can include, for example, mechanical abutments, at least one pivot device, at least one clamping device, colour markings, scales, etc. A lift device can comprise a housing which forms at least one receiving region in which the marking device is arranged at least in part. A protected and secure arrangement of the marking device can thereby be achieved.

In the case of fixing of the marking device to a lift cage device this lift cage device is preferably formed by a cage door lintel of the cage door. This is particularly advantageous in the case of maintenance and/or mounting, in which lift components—particularly coupling means—provided for coupling of a shaft door leaf with a cage door leaf are positioned at shaft doors. By “coupling” between a shaft door leaf and a cage door leaf there is to be understood, in particular, a mechanical connection between a shaft door leaf and the cage door leaf, which transmits an opening or closing movement of the cage door leaf to a respectively corresponding shaft door leaf when the lift cage is opposite a shaft door.

The light emission unit preferably comprises at least one laser for generating the lift beam. A precise marking and an accurate positioning of the lift components to be positioned can thereby be achieved. Moreover, through the use of a laser it is possible to characterise lift components spaced far from the light emission unit.

With advantage, the marking device comprises at least one beam shaping means, which is preferably exchangeable and which so influences the light beam that a particularly advantageous optical marking can be achieved. A particularly informative optical marking can be achieved if the marking device comprises at least one optical lens and/or a tens prism as beam shaping means. The light beam can thus, for example, be spread out in such a manner in one plane or two planes that a straight line or two straight lines at right angles to one another can be marked by the spread-out light beam on the object to be marked.

In a preferred form of embodiment of the invention the marking device comprises at least one fastening means which is formed as a magnet. A simple fastening of the marking device, for example to a reference element of the lift installation, can thus be achieved.

With advantage, the marking device comprises at least one battery and/or accumulator, whereby a simple power supply for a marking device, which is freely displaceable in the lift installation, can be achieved.

If the marking device has a mains current connection, a reliable energy supply, for example recharging of the accumulator, can be achieved.

A precise positioning of the light emission unit can be achieved if the marking device comprises at least one adjusting means. The adjusting means is preferably formed as a screw, whereby a stepless adjustability is achievable.

Moreover, it is proposed that the marking device comprises at least one positioning unit with at least one bend for positioning of the marking device. An accurate positioning of the marking device can be achieved by such a positioning unit.

With advantage, the marking device comprises at least two light sources, whereby a more flexible capability of use is achievable. In particular, a convenient capability of maintenance can be achieved. In particular, several objects present in the lift installation can be marked at the same time.

With advantage, the marking device comprises at least one mounting unit which movably mounts the light emission unit. In that case, by the term “movably mounted” there is to be understood, in particular, that the light emission unit in a mounted state is formed to be movable relative to at least one component of the marking device. A flexible capability of use of the marking device can thereby be achieved. A constructionally simple build can be achieved if the mounting unit rotatably mounts the light emission unit.

Moreover, a marking method is proposed in which a marking device and a lift device come into use in accordance with the foregoing description and in which at least one lift component or the intended mounting point of at least one lift component is marked by at least one light beam. A simple maintenance and/or mounting of a lift component can be achieved by such a method. In particular, a component of a shaft door can be arranged precisely relative to an element of a lift cage device, whereby, in particular, a low output of noise, particularly at the time of opening closing of lift doors, is achievable.

Advantageously, in the marking method at least one target position of at least one lift component is marked. A simple and accurate positioning of the lift component can thereby be achieved at the time of installation or maintenance of the lift installation.

According to a further embodiment of the marking method at least one already-installed lift component, which is to be adjusted and/or checked and/or maintained, and/or the mounting point of at least one lift component to be mounted is or are marked in the sense of a characterisation. In this manner, for example, lift components to be maintained in accordance with a work plan or the mounting points of lift components to be installed can be characterised in succession. It can thus be ensured that every planned procedure is executed, wherein on each occasion the correct lift component is adjusted or each lift component to be installed is installed at the intended mounting point. In addition, it is possible to achieve, in particular, a smaller outlay in terms of time for the installation or maintenance of the lift installation.

Moreover, a marking method is proposed in which at least one lift component which is a part of a shaft door is marked by a positioning marking and in which an engineer in a lift cage positions this lift component via an opened cage door with the help of the positioning marking. A convenient positioning can thereby achieved.

In addition, a marking method is proposed in which a lift component which is part of a shaft door is marked by at least one positioning marking generated by at least one light beam and in which an engineer who is on a roof of a lift cage device positions the lift component on the basis of the positioning marking. A simple capability of maintenance and/or capability of mounting can be achieved in this manner. In particular, a maintenance and/or a mounting of a lift component which is part of an uppermost shaft door of a lift installation can be performed in simple manner.

Moreover, it is proposed that before positioning of a lift component the lift cage is moved into a position in which the cage door of the lift cage is displaced in height with respect to the corresponding shaft door. A maintenance and/or mounting position convenient for the engineer can thereby be achieved. In particular, when the lift component to be adjusted is a coupling means which is mounted on a shaft door and which is to be aligned relative to an entrainer device mounted on a cage door it is possible to select a cage position in which an engineer standing in the lift cage can adjust the coupling means via the opened cage door at a comfortable working height. The adjustment in that case is carried out on the basis of a marking which is generated by a marking device preferably fastened to the cage door lintel of the lift cage, wherein the lift cage is so positioned that the cage door lies above the corresponding shaft door by, for example, approximately a metre.

Further advantages are evident from the following drawing description. Exemplifying embodiments of the invention are illustrated in the drawing. The drawing, description and claims contain numerous features in combination. The expert will advantageously also consider the features individually and combine them into feasible further combinations.

There:

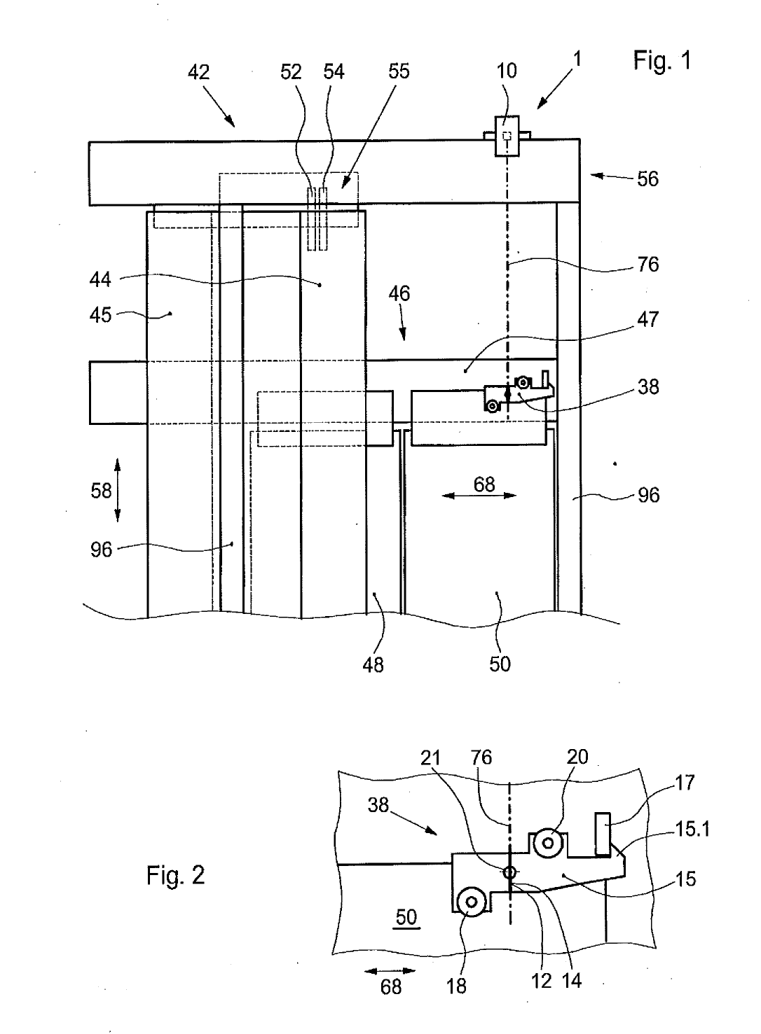

FIG. 1 shows a view, as seen from the interior of a lift cage, of
a partly opened cage door,
a lift cage device, which is formed by the cage door lintel of the lift cage, with a marking device fastened to the lift cage device,
a shaft door, which is arranged behind the cage door, with coupling means arranged at this,
wherein the cage door is so positioned that the shaft door is offset in height relative to the cage door,

FIG. 2 shows a detail view of the coupling means according to FIG. 1,

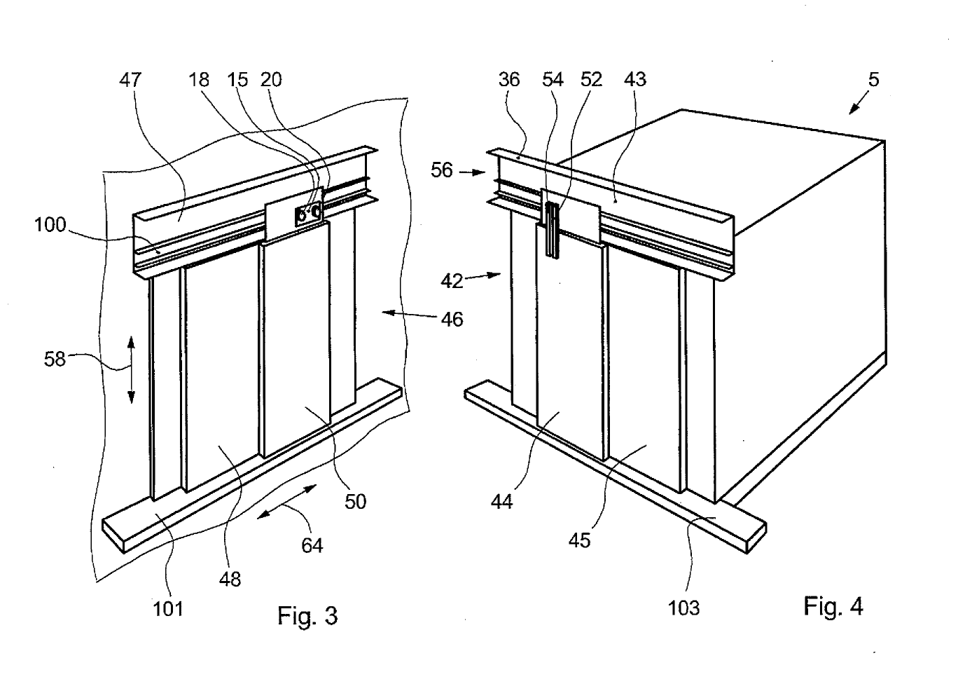

FIG. 3 shows a schematic view of a shaft door,

FIG. 4 shows a schematic view of a lift cage device which is constructed as a lift cage and which serves as a carrier of the marking device,

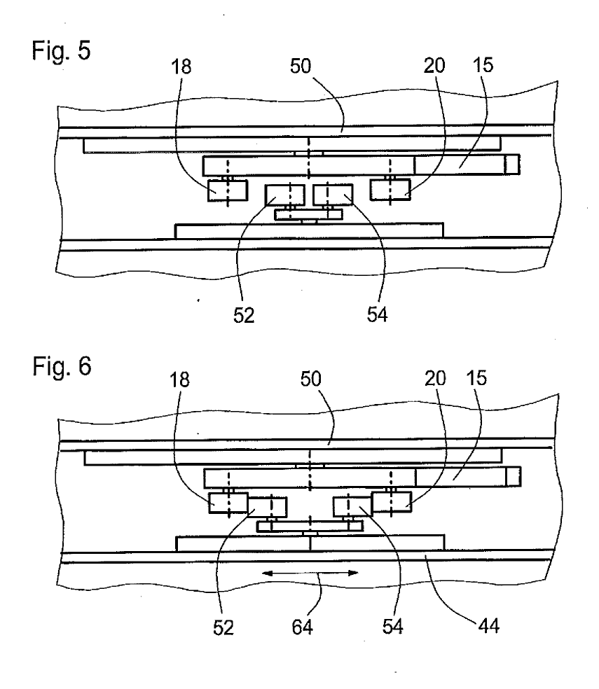

FIG. 5 shows a plan view of a coupling device, which couples the cage door with a shaft door, in uncoupled setting for travel past,

FIG. 6 shows a plan view of a coupling device, which couples the cage door with a shaft door, in coupling setting,

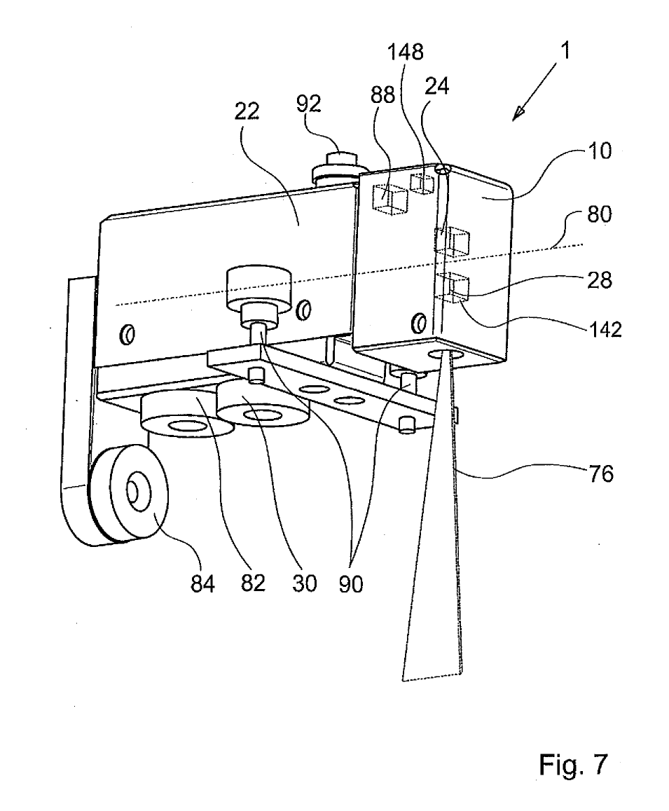

FIG. 7 shows a view of the marking device,

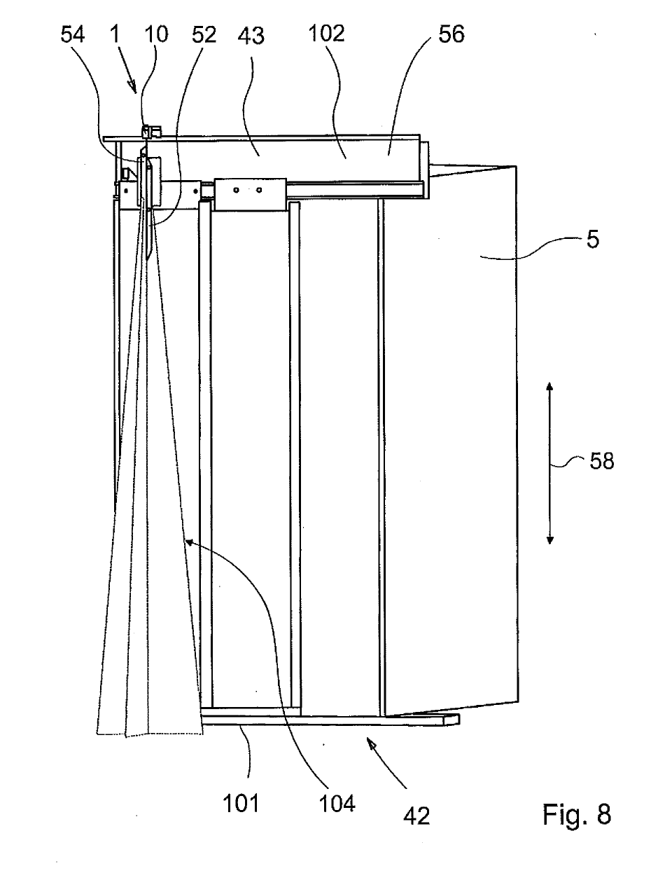

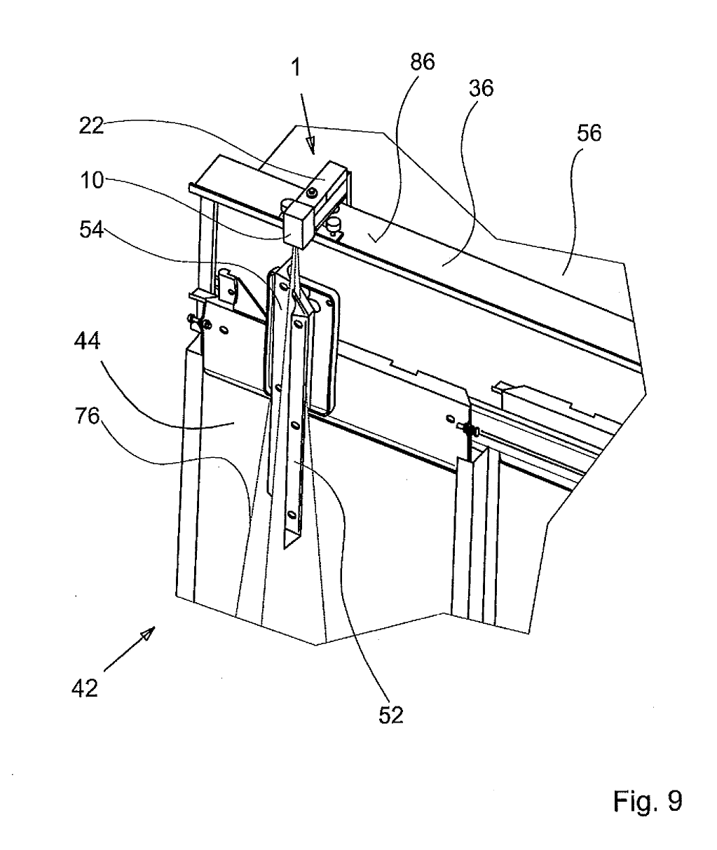

FIG. 8 shows a view of the lift cage, which serves as lift cage device, with the marking device in an operating state,

FIG. 9 shows a detail view of a part of the lift cage device and the marking device in the operating state according to FIG. 8,

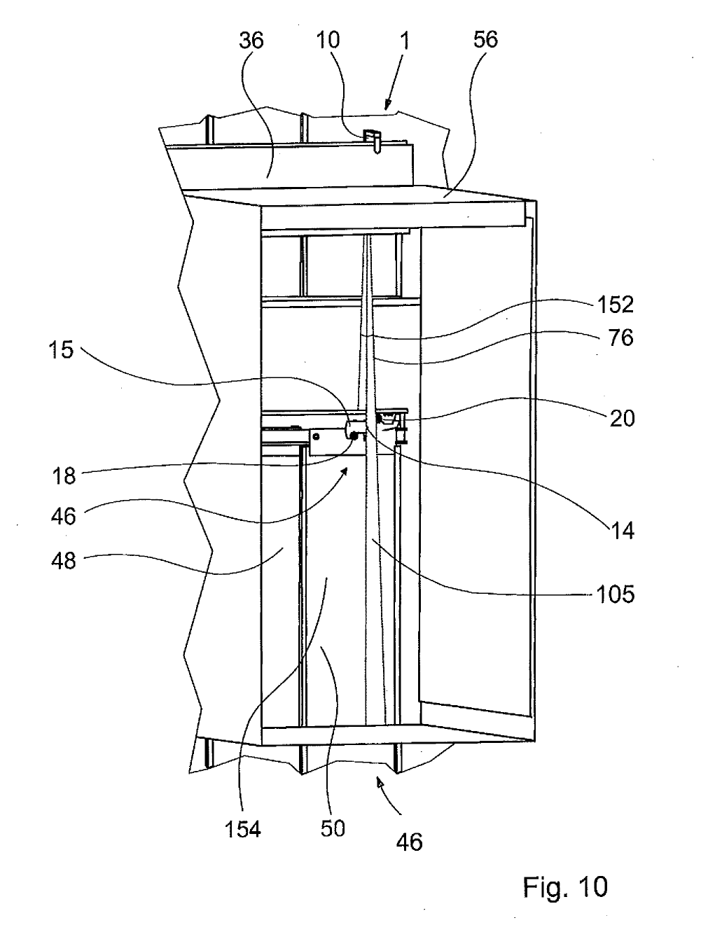

FIG. 10 shows a view of the lift cage, which serves as lift cage device, and the marking device fastened thereto, wherein the lift cage is positioned above the storey level with the corresponding shaft door and the marking device emits a downwardly directly light beam which forms a beam plane,

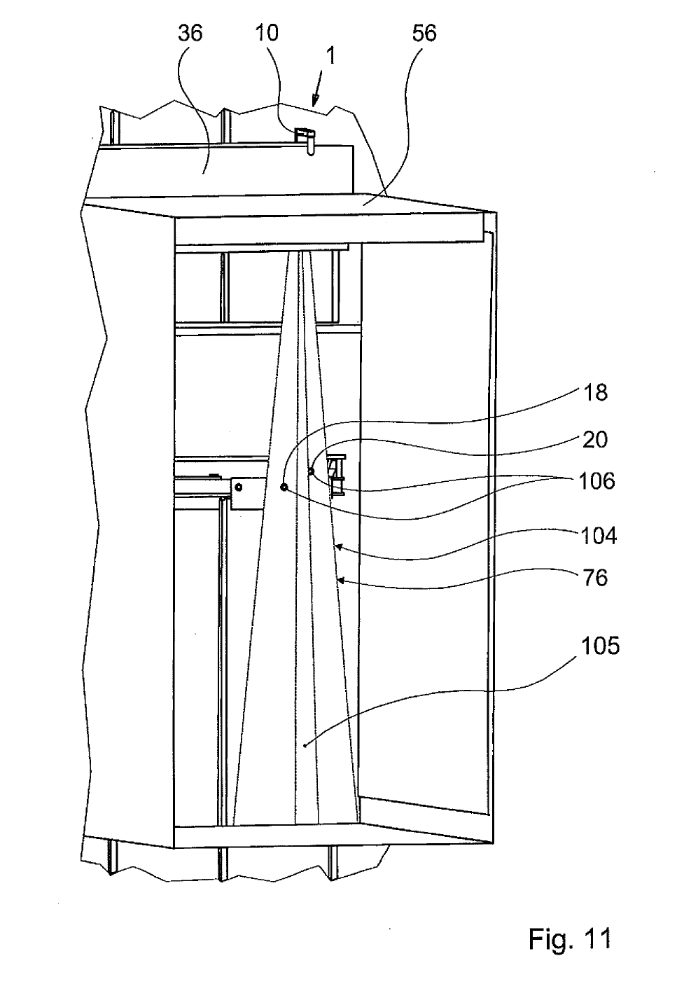

FIG. 11 shows a view as in FIG. 10, wherein the marking device emits a downwardly directly light beam which forms two intersecting beam planes,

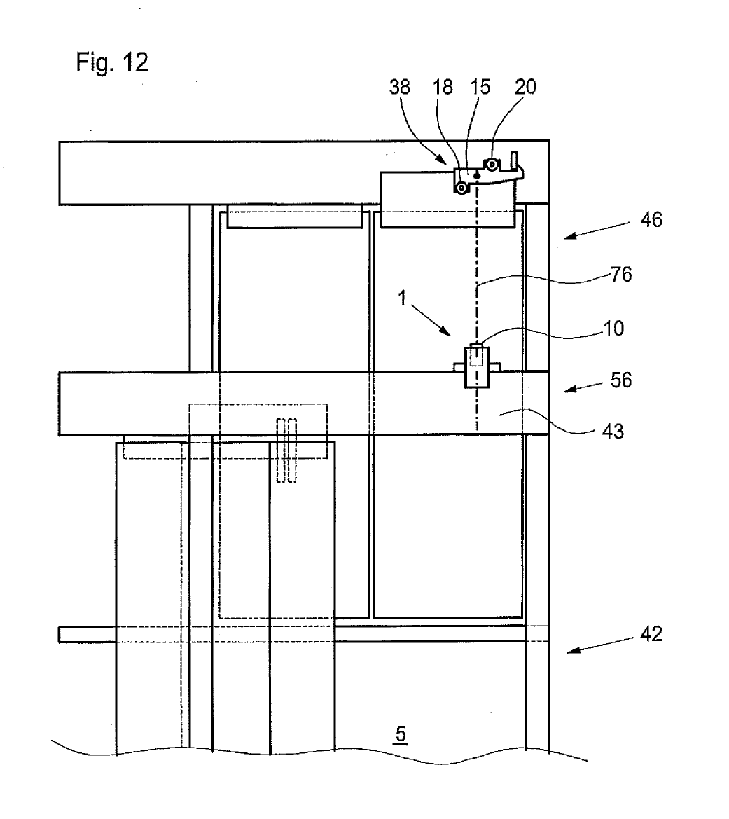

FIG. 12 shows a view of a part of a lift cage device in a further operating state, in which the marking device emits a vertically upwardly directed light beam,

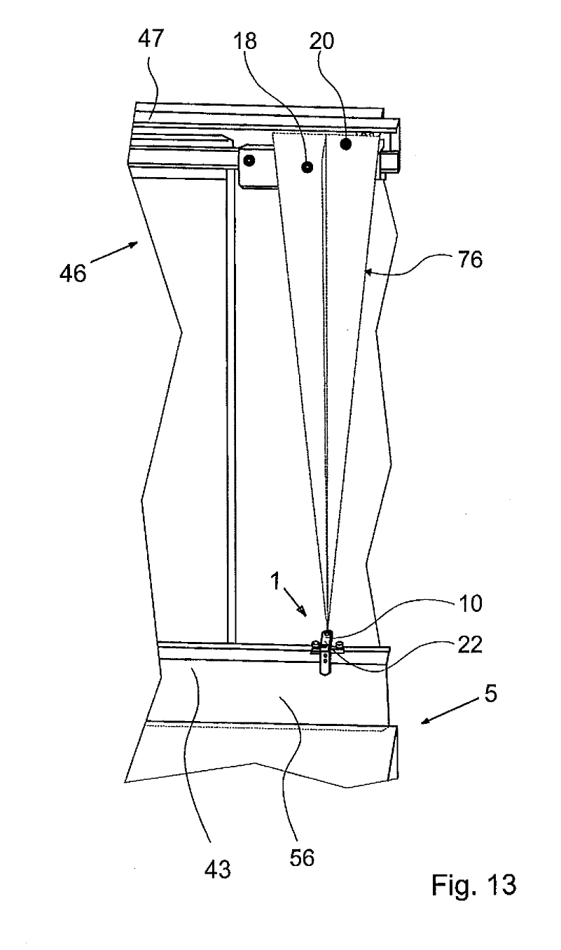

FIG. 13 shows a view of part of the lift device in a further operating state, in which the lift cage is positioned below the storey level with the corresponding shaft door and the marking device emits an upwardly directed light beam which forms two intersecting beam planes,

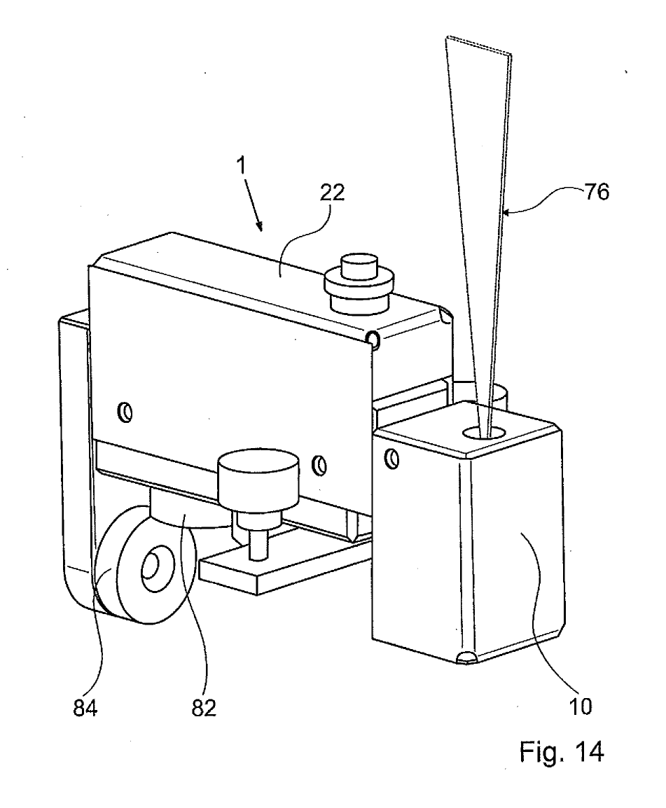

FIG. 14 shows a view of the marking device in an operating state in which the marking device emits an upwardly directed light beam which forms one beam plane,

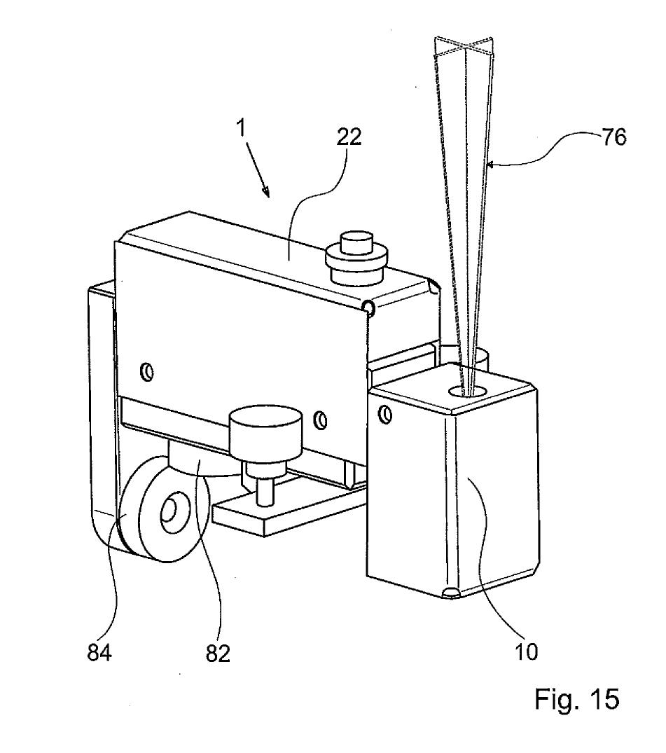

FIG. 15 shows a view of the marking device in an operating state in which the marking device emits an upwardly directed light beam which forms two intersecting beam planes,

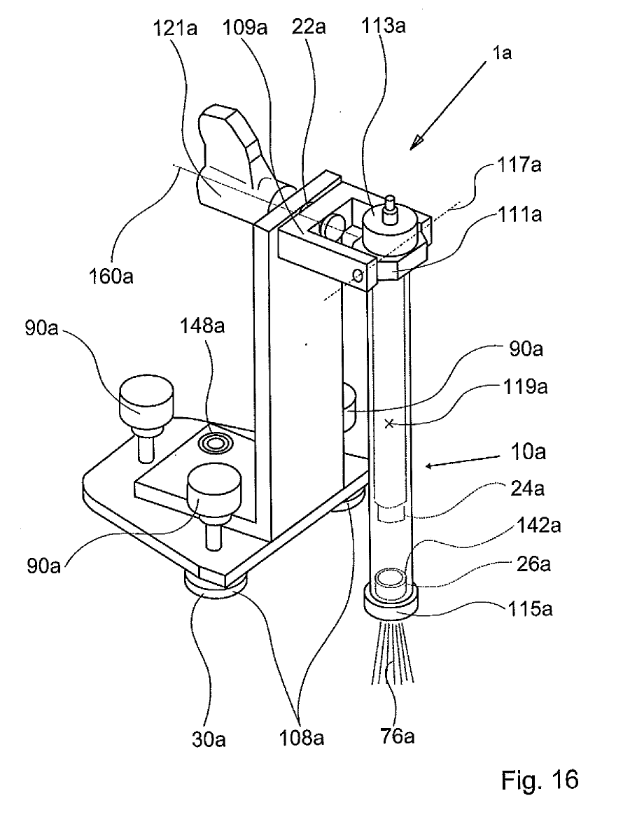

FIG. 16 shows a view of an alternative exemplifying embodiment of a marking device,

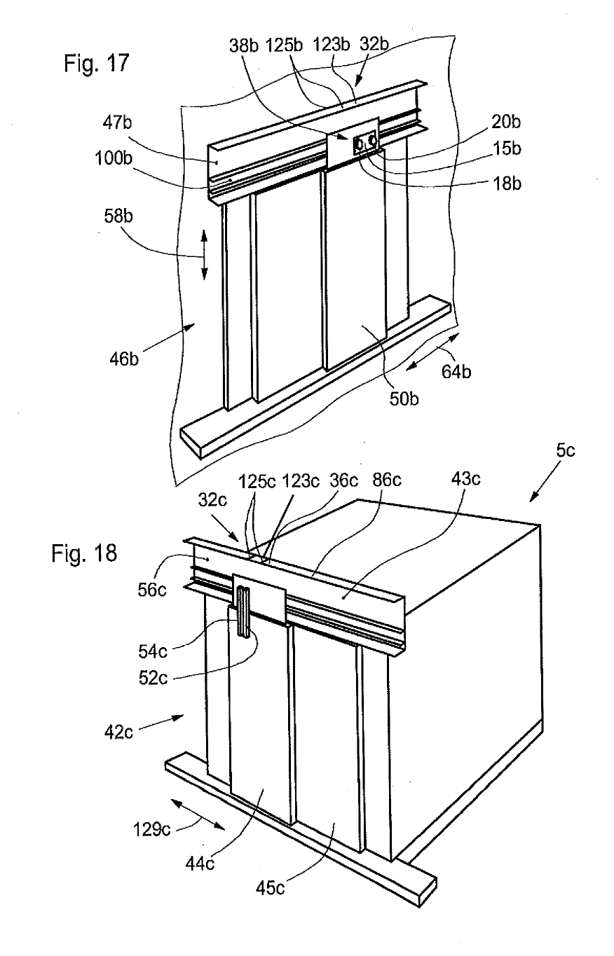

FIG. 17 shows a view of a lift shaft device formed by a shaft door,

FIG. 18 shows a view of a lift cage device formed by a lift cage and

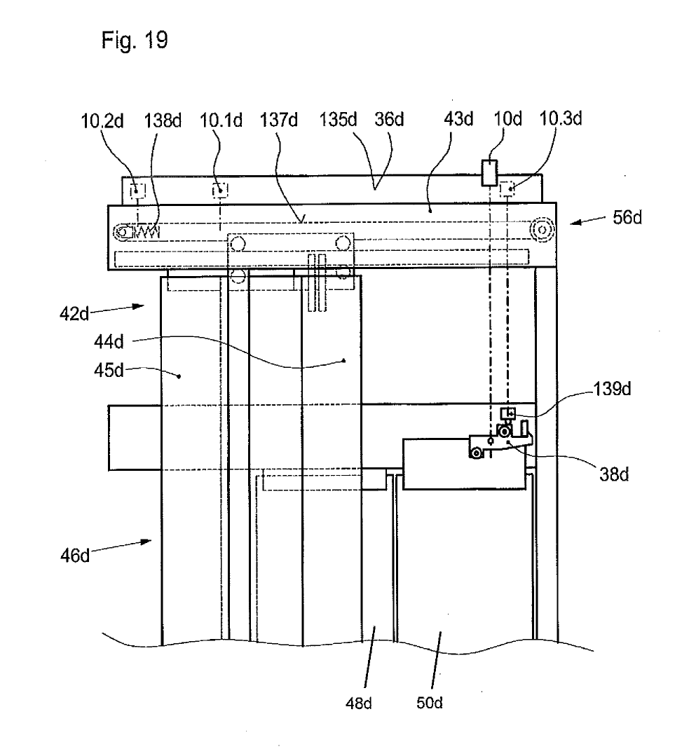

FIG. 19 shows a view of an alternative exemplifying embodiment a lift device with an alternative exemplifying embodiment of a marking device.

FIG. 1 shows a view from the interior space of a lift cage (not illustrated here) onto a cage door 42 with two partly opened cage door leaves 44, 45 and onto a shaft door 46, which is arranged therebehind, with closed shaft door leaves 48, 50. Two skid-shaped coupling parts 52, 54 at the cage door side are mounted on the cage door leaf 44 and belong to an entrainer device 55. Also illustrated is a lift cage device 56 which belongs to the lift cage 5 and which is formed by the cage door lintel 43 of the cage door 42 and carries a marking device 1 according to the invention. The cage door 42 additionally comprises two door posts 96 which together with the cage door lintel 43 form part of a cage door frame. The marking device 1 comprises a light emission unit 10 with a laser 24 which generates a vertically directed light beam 76. The marking device is in that case so positioned that the position of the light beam 76 in horizontal direction corresponds with the position in which the centre of the entrainer device 55 is located when the cage door leaf 44 adopts its closed setting. In the case of an intended operating process the marking device 1 generates a marking 12 (FIG. 2) in the form of a light mark on an object detected by the light beam. The marking 12 is formed as a positioning marking 14 and in the illustrated exemplifying embodiment serves for the positioning of a coupling means 38, which is at the shaft door side, with two shaft door rollers 18, 20 relative to the coupling parts 52, 54 at the cage door side.

FIG. 2 shows the said coupling means 38 at the cage door side in enlarged illustration.

The coupling parts 52, 54 at the cage door side are connected with the cage door leaf 44 and both have substantially the form of a vertically oriented runner (FIGS. 1 and 4). During an opening or closing process of the cage doors the coupling parts 52, 54 at the cage door side move synchronously with the cage door leaf 44. The coupling means 38, which is at the shaft door side, with the two shaft door rollers 18, 20 is mounted on a shaft door leaf 50 of the shaft door 46 and forms together with the coupling parts 52, 54 at the cage door side a cage door/shaft door coupling when the cage door and a corresponding shaft door are opposite at the same level. For opening of the shaft door respectively opposite the lift cage the distance between the two coupling parts 52 and 54 at the cage door side is increased so that these press against the shaft door rollers 18, 20 of the coupling means 38 at the shaft door side. On the one hand the coupling means 38 at the shaft door side is thereby rotated in clockwise sense, whereby a locking hook 15.1 connected with the coupling means 38 at the shaft door side is lowered and thus unlocks a shaft door lock. Such a shaft door lock is formed in that when the shaft door is closed the locking hook 15.1 connected with the coupling means 38 at the shaft door side latches with a locking stop 17 which is fixedly connected with the shaft door lintel 47 of the shaft door 46 (FIG. 2). On the other hand, the mentioned increase in the distance between the two coupling parts 52 and 54 at the cage door side produces a play-free coupling, which provides a mechanically positive couple in horizontal direction, between these coupling parts and the shaft door rollers 18, 20 of the coupling means 38 at the shaft door side and thus between the cage door leaf 44 and the shaft door leaf 50. A coupling part 15 at the shaft door side and the shaft door rollers 18, 20 together form the afore-mentioned coupling means 38 at the shaft door side, which is mounted on an axle 21 to be rotatable, but non-displaceable, on the shaft door leaf 50.

By way of the positioning marking 14, which makes a target position recognisable, an engineer who is in the lift cage can conveniently position the coupling means 38 at the shaft door side in that the engineer arranges the coupling means 38 at the shaft door side in a defined position relative to the reference position given by the position of the coupling parts 52 and 54 at the cage door side. Before the arranging or positioning of the coupling means 38 at the shaft door side can be carried out the lift cage is moved into a position in which the cage door 52 is arranged to be offset in vertical direction relative to the corresponding shaft door 46 (FIG. 1). It is thereby achieved that the coupling means 38 which is at the shaft door side and to be positioned is disposed during the positioning process at a working height convenient for the engineer standing in the lift cage.

If the lift cage with the cage door 42 and with the lift cage device 56 moves during operation of the lift in vertical direction 58 to the cage position corresponding with the shaft door 56 then the coupling parts 52, 54 at the cage door side move in between the shaft door rollers 18, 20 of the coupling means 38 at the shaft door side. If a stop of the lift cage device 56 at the storey to which the shaft door 46 belongs is intended, then the coupling parts 52, 54 at the cage door side thus move, after they have moved in between the shaft door rollers 18, 20, from a travel-through position (FIG. 5), which they adopt during travel of the lift cage, in mutually opposite horizontal directions into a coupling position (FIG. 6) in which the coupling part 52 at the cage door side bears against the shaft door roller 18 and the coupling part 54 at the cage door side bears against the shaft door roller 20. In that case, as already mentioned above, the coupling means 38 at the shaft door side with the locking hook 15.1 rotates and thus unlocks the shaft door leaf 50 and couples the cage door leaf 44 with the shaft door leaf 50.

The positioning marking 14 generated on the coupling means 38 at the shaft door side particularly during maintenance or mounting work is used for the purpose of so arranging and fastening the coupling means 38 at the shaft door side that the positioning marking 14 is arranged with respect to a horizontal direction 68 in the centre between the two shaft door rollers 18, 20. If the two shaft door rollers 18, 20 have the same size spacing 74 from the light beam 76 or from the positioning marking 14 generated by the light beam of the light emission unit 10 then the coupling means 38 at the shaft door side is located in its target position. The shaft door rollers 18 thereby reach and contact the coupling part 52 at the cage door side, and the shaft door rollers 20 reach and contact the coupling part 54 at the cage door side, at the same time during the movement of the coupling parts at the cage door side from the travel-through position to the coupling position, whereby a high output of noise, particularly during this movement and particularly during a movement of the shaft door leaves 48, 50 with the help of the lift components 52, 54, is avoided.

The coupling parts 52, 54 at the cage door side are movably connected with the cage door leaf 44 of the cage door 42. In the coupling position (FIG. 6) these coupling parts 52, 54 at the cage door side are immovable relative to one another with respect to a width direction 64 of the shaft door 42, which is equally a width direction of the cage door 42 of the lift cage 5. In the coupling position (FIG. 6) the shaft door rollers 18, 20 are mechanically positively coupled with the coupling parts 52, 54 at the cage door side with respect to a width direction 64 of the shaft door 46, i.e. in the direction of the opening or closing movement of the door leaf. Movements of the cage door leaf 44 of the cage door 42 (FIG. 4) of the lift cage 5 in the direction of the width direction 64 are thereby transmitted to the door leaves 48, 50 of the shaft door 46 (FIGS. 1 and 3). The width direction 64 extends horizontally in the direction of the opening and closing movement of the door leaf. During opening of the cage door leaves 44, 45 the shaft door 46 is similarly opened, due to the unlocking of the shaft door lock and due to the coupling between the cage door leaf 44 and the shaft door leaf 50, by the coupling parts 52, 54 at the cage door side and the coupling means 38 at the shaft door side. In this regard the skid-shaped coupling parts 52, 54 at the cage door side act as entrainer device 55.

The marking device 1 serving at least for aligning the coupling means 38 at the shaft door side comprises a mounting unit 22 which mounts the light emission unit 10 to be rotatable about an axis 80 of rotation, which axis extends horizontally in a specific operating state (FIG. 7). A lens prism 28 of the light emission unit 10 so spreads out the light beam of the laser 24 that it is formed into a light beam 76 which propagates in a beam plane so that it marks a straight line on a planar surface arranged at right angles to the main direction of the light beam. The lens prism 28 forms a beam shaping means 142, which is preferably exchangeable. The light emission unit 10 is also so settable—particularly by exchange of the beam shaping means 142—that the light beam 76 generates two intersecting lines or a punctiform marking on a planar surface arranged at right angles to the main direction of the light beam. The marking device 1 comprises a levelling unit 148 which is formed as a spirit level and which is provided for horizontal orientation of the marking device. In order to set specific rotational positions of the light emission unit 10, which are each uniquely characterised by a specific rotational angle with respect to the axis 80 of rotation, the marking device comprises a detent unit (not illustrated) having at least four detent points. Fixing of the light emission unit 10 in rotational positions which preferably arise from rotations about the axis 80 of rotation through 90 degrees from one another is achievable by means of the detent points. In an operating position, which is aligned by means of the levelling unit 148, of the marking device the light emission unit 10 in the defined rotational positions preferably radiates in a horizontal direction or in a vertical direction.

In addition, the marking device comprises fastening means 30, 82, 84 which are constructed as magnets. Alternatively or additionally the marking device can comprise fastening means for fastening, by mechanically positive and/or frictional and/or material coupling, of the marking device to a lift cage device or to a lift shaft device. A fastening of the marking device can in addition by realised by means of a clamping device or by screws, rivets and/or welding. The lift cage device 56 comprises a fastening unit 36 which is formed by the cage door lintel 43 (FIGS. 8 and 9). The fastening unit 36 has a planar surface 86 which has exclusively horizontal area dimensional directions. The fastening means 30, 82 of the marking device lie on the surface 86 and fasten the marking device to the fastening unit 36, which is of metal construction. The fastening means 84 of the marking device additionally bear against a further surface of the fastening unit 36, which has a vertical area dimensional direction (not illustrated). The fastening means 30, 82, 84 define a bend (FIG. 7). The bend is provided for positioning the marking device. The marking device has a battery 88 for supply of current to the laser 24. In principle, the marking device can also have a current connection interface.

Moreover, the marking device 1 comprises two adjusting screws 90 by means of which a fine adjustment of a direction of the light beam 76 is performable. Moreover, provided at an upper side of the marking device is a switch 92 for switching on the marking device.

A light emission unit 10 mounted on a lift cage device 56 can in addition be positioned so that during a maintenance or mounting procedure it generates by way of the spread-out, vertically directed light beam 76 a marking by means of which, for example, the door posts 96 (FIG. 1) of the shaft door 46 are alignable parallel to the light beam 76. Moreover, the light emission unit 10 is rotatable through 90 degrees so that the main direction of the light beam corresponds with the horizontal direction. The shaft door lintel 47 and a guide rail 100 of the shaft door 46 can thereby be marked by means of the spread-out light beam and horizontally aligned (FIG. 3). In this setting a shaft door sill 101 can similarly be marked by a horizontally extending light marking, whereby the shaft door sill is alignable horizontally. For this purpose the lift cage (5) and thus the marking device are to be positioned at a height suitable for marking the respective lift component.

Alternatively, the cage door sill 103 of the cage door 42 (FIG. 3) and the shaft door sill 101 of the shaft door 46 can be adjusted by means of the marking device in that the light beam 76 is so shaped by a beam shaping means that it propagates in one plane or in two beam planes intersecting at right angles. In that case, the one beam plane 104 of the light beam 76, which is oriented vertically in its main direction, marks a straight line on at least one of the said door sills (FIG. 8). A respective longitudinal edge of each of the two door sills is then to be oriented parallelly to this straight line.

FIG. 10 shows a maintenance situation in which the light beam 76, which is radiated by the light emission unit, propagates in a beam plane 105 extending at right angles to a surface of the front side 154 of the shaft door leaf 50 and in vertical direction. The beam plane 105 has an opening angle (spread angle) 152 which has the effect that the light beam 76 can generate a positioning marking 14 at a planar surface of a lift component (here the coupling part 15 at the shaft door side), which extends parallel to the (here vertical) main direction of the light beam 76. The positioning marking 14 has in that case the form of a line which extends parallelly to the said main direction (here in vertical direction).

FIG. 11 shows a maintenance situation in which the light beam 76 is so shaped by a beam shaping means that it propagates in two beam planes 104, 105 intersecting at right angles. Marking lines can thus be generated at planar surfaces of lift components which extend substantially parallelly to the main direction of the light beam 76 and parallelly to one of the beam planes 104, 105. Moreover, as shown in FIG. 11, for example, the end surfaces 106 of the shaft door rollers 18, 20 can thereby be adjusted parallelly to the beam plane 104 of the light beam 76.

As illustrated in FIGS. 12 and 13, the light emission unit 10 of the marking device 1 can, for positioning of lift components (here the coupling part 15 and the shaft door rollers 18, 20 of the coupling means 38 at the shaft door side), also radiate the light beam 76 upwardly in vertical direction. The marking device 1 with the light emission unit 10 is in that case preferably fixed on the cage door lintel 43, which serves as lift cage device, of the lift cage 5. An upwardly directed light beam is particularly advantageous when the shaft door 46 to be adjusted is that which is assigned with the uppermost part of the lift shaft and accordingly an adjustment of the said lift components 15, 18, 20 by the engineer cannot be carried out from the lift cage 5. In this case the engineer stands on the roof of the lift cage 5 in order to carry out the said adjustments, wherein the lift cage 5 is moved into a position in which the cage door 42 is displaced downwardly relative to the shaft door 46 to such an extent that the engineer can conveniently position the coupling means 38 at the shaft door side by way of the upwardly directed light beam 76. In this situation use can also be made of a light beam 76 with two beam planes intersecting at right angles (FIG. 13).

In a particularly advantageous form of embodiment of the marking device or of the marking method according to the invention the marking device includes a light emission unit which can radiate a light beam in opposite direction. Thus, it is no longer necessary to pivot the light emission unit through half a turn in order to be able to use the light beam in upward direction and also in downward direction.

FIG. 14 shows the marking device in an operational situation in which the light emission unit 10 radiates the light beam 76, which here forms one beam plane, upwardly in vertical direction.

FIG. 15 shows the marking device in a situation in which the light emission unit 10 similarly radiates the light beam 76, which here forms two beam planes crossing at right angles, upwardly in vertical direction.

In principle, it is also conceivable for the marking device to comprise further light emission units which simultaneously mark target positions of components to be positioned. Such components can be, for example, the shaft door sills, door posts of the shaft door 46 or of the cage door 42 and/or guide rails (not illustrated) of the lift cage 5.

Moreover, the marking device can be arranged at other locations of the lift cage 5 in order to characterise and/or align one of the many lift components present in a lift shaft. In addition, it is conceivable for a vertical position of the lift cage 5 to be determined with the help of the marking device, for example by means of a laser distance measurement.

Alternative exemplifying embodiments are illustrated in FIGS. 16 to 19. Components, features and functions remaining substantially the same are basically numbered by the same reference numerals. However, in order to distinguish the exemplifying embodiments the letters ‘a’, ‘b’, etc., are added to the reference numerals of the exemplifying embodiments in FIGS. 16 to 19. The following description is substantially confined to the differences from the exemplifying embodiment in FIGS. 1 to 15, wherein with respect to components, features and functions remaining the same reference can be made to the description of the exemplifying embodiment in FIGS. 1 to 15.

FIG. 16 shows an alternative exemplifying embodiment of a marking device 1a, which comprises three adjusting screws 90a. Each of the adjusting screws 90a has a respective end region 108a, which is arranged, for example, on the surface 86 of the cage door lintel 43 (FIG. 9). In the case of at least two of the three adjusting screws 90a the end region 108a is formed by a magnet. The marking device additionally comprises a mounting unit 22a which mounts a mounting means 109a of the marking device to be rotatable about an axis 160a of rotation, wherein the axis 160a of rotation extends horizontally in the illustrated operating state. The mounting 109a means is lockable by way of a fixing means 121a in a specific rotational position with respect to rotations about the axis 160a of rotation. A holding means 111a is mounted by the mounting means 109a to be rotatable about an axis 117a of rotation. The holding means 111a accepts a weight force of a light emission unit 10a of the marking device and mounts the light emission unit 10a to be translationally displaceable between two abutments 113a, 115a. A mass centre point 119a is, in an operating position, arranged in vertical direction below the axis 117a of rotation and thereby determines a position of the light emission unit 10a which is mounted to be freely rotatable about the axis 117a of rotation. Alternatively, it is obviously also possible for a blocking device to be present by which the rotation of the holding means 111a and thus of the light emission unit 10a about the axis 117a of rotation can be blocked in a desired setting.

The laser 24a is constructed as a laser diode. Moreover, the light emission unit 10a comprises a lens 26a which is constructed as a cross lens and defines a shape of cruciform light beam 76a. The lens 26a forms a beam shaping means 142a. The marking device 1a comprises a levelling unit 148a. The levelling unit 148a is formed by a box level.

FIG. 17 shows a lift shaft device, which is constructed as a shaft door lintel 47b of a shaft door 46b, with a mounting device 123b which is provided for carrying and fixing a marking device to be fixedly mounted in the lift shaft.

The mounting device 123b comprises positioning markings 125b which form a positioning device 32b for positioning the marking device. If the marking device is positioned on the mounting device 123b or on the door lintel, then the positioning of lift components in the lift shaft and also at the lift cage with respect to the position of the shaft door is possible. In a given case a fine adjustment of the position of the marking device is required beforehand, which can be undertaken by displacement of the marking device along a width dimensional direction 64b of the shaft door 46b.

FIG. 18 shows a lift cage device 56c which belongs to the lift cage 5c and which is constructed as part of a cage door lintel 43c. The lift cage device 56c comprises a mounting device 123c which is provided as a mount for a marking device. Mounted on the cage door lintel 43c are positioning markings 125c which form a positioning device 32c for positioning the marking device. If the marking device is positioned, then a positioning of lift components with respect to the position of the lift cage 5c or the coupling parts 52c and 54c at the cage door side is possible. In particular, a marking device fixed to the lift cage device 56e enables marking and orientation of lift components such as the coupling parts 15, which are at the shaft door side, with the shaft door rollers 18, 20 at the shaft door leaves 50b (FIG. 17). In a given case, for precise positioning of the lift components a fine adjustment of the marking device is required, which can be undertaken by a displacement of the marking device along a width dimensional direction 129c of the cage door 42c of the lift cage 5.

FIG. 19 shows, like FIG. 1, a view from the interior space of a lift cage (not illustrated here) onto a cage door 42d with two partly opened cage door leaves 44d, 45d and a shaft door 46d, which is arranged therebehind, with closed shaft door leaves 48, 50, with an alternative exemplifying embodiment of a marking device. Apart from the already known light emission unit 10d for positioning of the coupling means 38d at the shaft door side, this marking device comprises three further light emission units 10.1d, 10.2d, 10.3d which serve, in particular, the purpose of characterising lift components in the region of the shaft door 42d and the respective shaft doors 46d opposite the cage door or pointing to such lift components so that they are not overlooked or forgotten during a maintenance procedure. The light emission units 10.1d, 10.2d, 10.3d each include a laser (not illustrated) and are fixed on a support 135d which is mounted on a cage door lintel 43d serving as lift cage device 56d. The support 135d thus forms a fastening unit 36d for the light emission units 10.1d, 10.2d, 10.3d, wherein these are preferably easily mountable and demountable in order to be able to be used in different lift installations. Such a support with the light emission units fixed thereto can obviously also be permanently installed in a lift installation.

During a maintenance or mounting operation the light emission unit 10.1d marks a cable 137d which moves a cage door leaf 44d of the cage door 42d during an opening or closing movement of the lift doors. The light emission unit 10.1d directs the engineer to the cable 137d so that the engineer checks the state of the cable. A further light emission unit 10.2d marks a compression spring 138 which determines the cable tension of the cable 137d. The light beam 76 of the light emission unit 10.2d marks the compression spring so as to direct the engineer to check the state of the spring and adjust the spring length of the compression spring so as to ensure a specific cable tension.

A third light emission unit 10.3d points to an electrical safety contact 139d, the function of which is to be checked during a maintenance procedure. The safety contact 139d has to conduct the current with a small voltage drop when the associated shaft door leaf 50d of the shaft door 46d is closed.

Moreover, it is conceivable that at least one of the light emission units 10.1d, 10.2d, 10.3d during at least one operating process produces a positioning marking for positioning at least one lift component.

In addition, it is conceivable that the light emission units 10.1d, 10.2d, 10.3d carry out characterising or marking processes in succession, i.e. the individual light emission units are activated in succession by means of a control unit in correspondence with a mounting or maintenance plan.

Marking devices in accordance with the invention with a light emission unit or with several light emission units can be fixedly or temporarily installed at the most diverse places in a lift installation in order to position lift components relative to a reference element or in order, during mounting or maintenance procedures, to indicate mounting locations of lift components or already installed lift components.

For mounting and maintenance purposes use could be made of marking devices in which a light emission unit is pivotable about at least two axes, wherein the pivot movements can be executed by means of controllable and regulable positioning motors. It is thus possible to quickly and precisely mark a plurality of mounting locations and/or positioning markings sequentially by a light beam in accordance with a mounting or maintenance plan. The work effort can thus be minimised and a low probability of error achieved. A possible development of the invention consists in that the laser present in the light emission unit is constructed as a distance measuring laser in order to thus obtain even further adjustment possibilities for the positioning of components in lift installations.

1-9. (canceled)

10. A marking device in an elevator installation, comprising: a light emission unit being fixed to an elevator car device, the light emission unit being selectively operable to emit a light beam to produce a temporary marking indicating at least one of a target position for mounting an elevator component in the elevator installation, a reference position for positioning an elevator component mounted in the elevator installation, and an elevator component of the elevator installation for due for maintenance.

11. The marking device according to claim 10 wherein the elevator car device is a car door lintel.

12. The marking device according to claim 10 wherein the elevator component is a coupling means mounted on a shaft door leaf of the elevator installation.

13. The marking device according to claim 10 wherein the light emission unit includes a laser that emits the light beam.

14. The marking device according to claim 10 wherein the light emission unit includes a beam shaping means that spreads out the light beam to propagate in at least one plane.

15. The marking device according to claim 10 including at least one magnetic fastening means for fixing the light emission unit to the elevator car device.

16. The marking device according to claim 10 including at least two of the light emission unit producing spaced apart ones of the temporary marking.

17. A marking method for an elevator installation comprising the steps of:
providing a marking device having a light emission unit being selectively operable to emit at least one light beam;
fixing the marking device to an elevator car device of an elevator car;
operating the light emission unit to emit the a light beam to produce a temporary positioning marking in the elevator installation; and
at least one of mounting and positioning an elevator component with reference to the positioning marking from a roof of the elevator car or from the elevator car through an opened car door.

18. The marking method according to claim 17 including marking a target position at which the elevator component is to be positioned during the positioning step.

19. The marking method according to claim 17 including fixing the marking device to a car door lintel of the elevator car.

20. The marking method according to claim 17 including before positioning of the at least one elevator component, moving the elevator car into a position at which a car door lies above or below an adjacent shaft door.

21. The marking method according to claim 17 wherein the elevator component is a coupling means at a shaft door side or a shaft door roller of the coupling means at the shaft door side.

22. A marking device in an elevator installation, comprising: at least one light emission unit being fixed to an elevator car device, which device is formed by a car door lintel of an elevator car, the at least one light emission unit being selectively operable to emit at least one light beam to produce at least one temporary positioning marking on at least one elevator component in the elevator installation.

23. The marking device according to claim 22 wherein the at least one light emission unit includes a laser that emits the at least one light beam.

24. The marking device according to claim 22 wherein the at least one light emission unit includes a beam shaping means that spreads out the at least one light beam to propagate in at least one plane.

25. The marking device according to claim 22 including at least one adjusting screw engaging the elevator car device for selectively adjusting a direction of the at least one light beam.

26. The marking device according to claim 22 including a mounting unit, the at least one light emission unit being rotatably attached to the mounting unit for rotation about an axis of rotation.

27. The marking device according to claim 26 including a fixing means for locking the at least one light emission unit in a selected rotational position.

28. The marking device according to claim 26 including a holding means attached to the mounting unit for rotating the at least one light emission unit about another axis of rotation.
